(19) United States
(12) Patent Application Publication
(10) Pub. No.: US 2017/0345041 A1
(43) Pub. Date: Nov. 30, 2017

(54) SALES DATA PROCESSING APPARATUS AND METHOD FOR DETECTING UNFAIR ACQISITION OF POINT VALUE BY THE SAME

(71) Applicant: TOSHIBA TEC KABUSHIKI KAISHA, Tokyo (JP)

(72) Inventor: Tomohiro Kondo, Mishima (JP)

(21) Appl. No.: 15/168,304

(22) Filed: May 31, 2016

(51) Int. Cl. G06Q 30/02

(52) U.S. Cl. CPC G06Q 30/0225; G06Q 30/0226

(57) ABSTRACT

A sales data processing apparatus comprises a reading module configured to read an owner identification information of a point card, a point providing module configured to carry out a point providing processing in which a point value is added to the point card of which the owner identification information is read by the reading module, a storage module configured to store the owner identification information of the point card to which the point providing processing is carried out and a use count information of the point card, and a notification module configured to output a notification signal if the use count information of the point card, stored in the storage module, which is indicated by the owner identification information read by the reading module is greater than a threshold value.

### CROSS-REFERENCE TO RELATED APPLICATION

This application is based upon and claims the benefit of priority from Japanese Patent Application No. 2015-073126, filed Mar. 31, 2015, the entire contents of which are incorporated herein by reference.

### FIELD

Embodiments described herein relate to a sales data processing apparatus and a method for detecting an unfair acquisition of a point value by the sales data processing apparatus.

### BACKGROUND

Conventionally, a system is introduced to each retail store that adds points corresponding to a settlement amount to accumulated points of a point card owned by a customer. A customer receives a point card through a pre-registration operation. The point card is read at the time of settlement of purchased commodities with a POS (Point of Sales) terminal serving as a sales data processing apparatus, and thus points corresponding to the settlement amount can be added to the accumulated points of his or her point card. The points can be used as a value of money at the time of the next and subsequent purchase of a commodity.

However, among the customers, there are some customers who do not present the point card at the time of the settlement processing with the POS terminal because they left his or her point card at home or a point card is not pre-issued. In this case, there may be a possibility of an internal unfair practice that a cashier inadequately uses his or her own point card to snatch the generated points corresponding to the settlement amount of the customer.

### DESCRIPTION OF THE DRAWINGS

FIG. 1 is a diagram exemplifying the schematic structure of a POS system according to an embodiment;

FIG. 2 is an external perspective view illustrating a POS terminal shown as an example;

FIG. 3 is a diagram exemplifying the structure of the POS terminal;

FIG. 4 is a diagram exemplifying data structures of a setting file and threshold value data;

FIG. 5 is a functional block diagram illustrating the POS terminal;

FIG. 6 is a flowchart exemplifying a point processing operation carried out by the POS terminal;

FIG. 7 is a diagram exemplifying the setting state of the setting file;

FIG. 8 is a diagram exemplifying a notification screen in the POS terminal;

FIG. 9 is a functional block diagram of a POS terminal according to a first modification;

FIG. 10 is a diagram exemplifying the structure of a buzzer for notification according to a second modification;

FIG. 11 is a diagram exemplifying a display screen of a store computer according to a third modification;

FIG. 12 is a diagram exemplifying the structure of a POS terminal according to a fourth modification;

FIG. 13 is a flowchart exemplifying a processing carried out by a generation section; and

FIG. 14 is a diagram exemplifying a layout data.

### DETAILED DESCRIPTION

In accordance with an embodiment, a sales data processing apparatus comprises a reading module configured to read an owner identification information of a point card, a point providing module configured to carry out a point providing processing in which a point value is added to the point card of which the owner identification information is read by the reading module, a storage module configured to store the owner identification information of the point card to which the point providing processing is carried out and a use count information of the point card, and a notification module configured to output a notification signal if the use count information of the point card, stored in the storage module, which is indicated by the owner identification information read by the reading module is greater than a threshold value.

Hereinafter, the sales data processing apparatus and a method for detecting an unfair practice on a point value by the sales data processing apparatus of the embodiment are described in detail with reference to the accompanying drawings. In the present embodiment, an example of application to the POS terminal of a POS (Point of Sales) system is described as a sales data processing apparatus.

### Embodiment

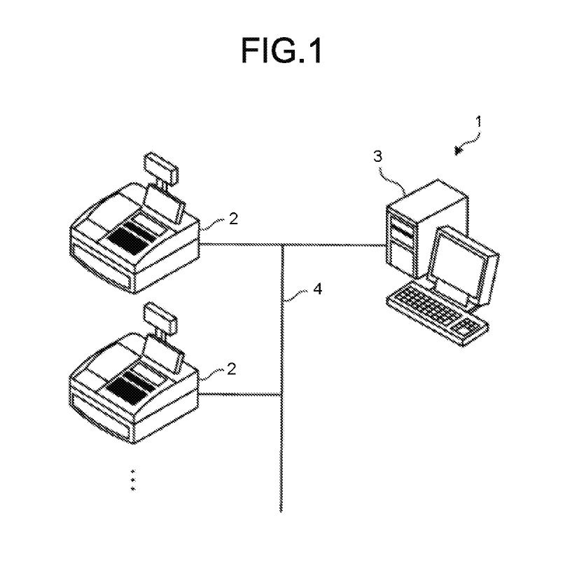

FIG. 1 is a diagram exemplifying the schematic structure of a POS system according to the embodiment. As shown in FIG. 1, the POS system 1 includes a plurality of POS terminals 2 and a store computer 3. The store computer 3 is arranged in, for example, a management office, and the POS terminals 2 are arranged in parallel along a settlement register lane. The store computer 3 and each POS terminal 2 are connected with each other through a communication line 4 such as an LAN (Local Area Network).

The store computer 3 controls the whole of the POS system 1 and thus collectively manages the POS terminals 2 via the communication line 4. The store computer 3 has a computer structure, and thus includes a store controller, a keyboard, a display device, a communication interface and the like. The store controller is constituted with a CPU (Central Processing Unit), a ROM (Read Only Memory) and a RAM (Random Access Memory). The store controller has a function of collectively managing the POS terminals 2 through the execution of a program stored in the ROM by the CPU and performs an online-communication with a plurality of the POS terminals 2 via the communication interface.

The POS terminal 2 has a function of a checkout processing function and sends, for example, settled sales registration data to the store computer 3. Further, the POS terminal 2 has a point processing function and connects with a point providing server (not shown) that carries out authentication of a point providing to carry out the point processing. The connection of the POS terminal 2 to the point providing server is carried out via a communication line such as an LAN or a VPN (Virtual Private Network). The point processing will be described in detail later.

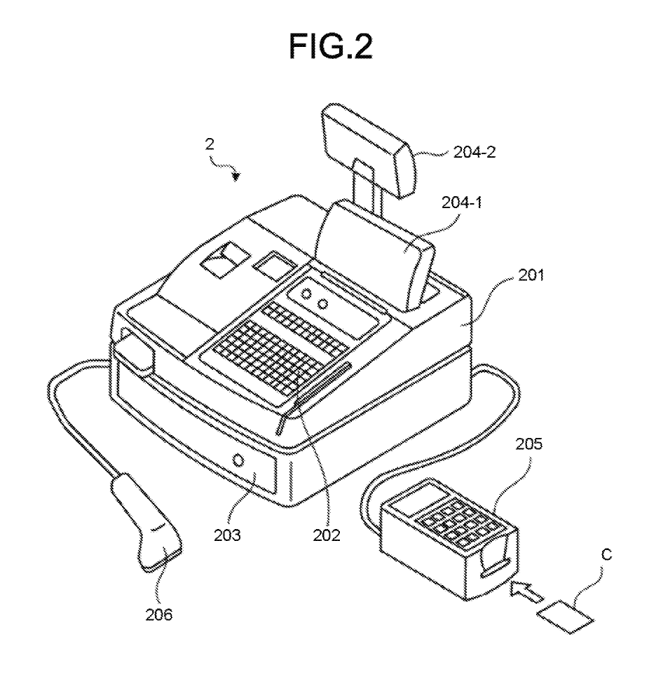

FIG. 2 is an external perspective view of the POS terminal 2 as an example. A main body 201 of the POS terminal 2, placed on a drawer 203 that is used to accommodate cash and the like, controls to open or close the drawer 203.

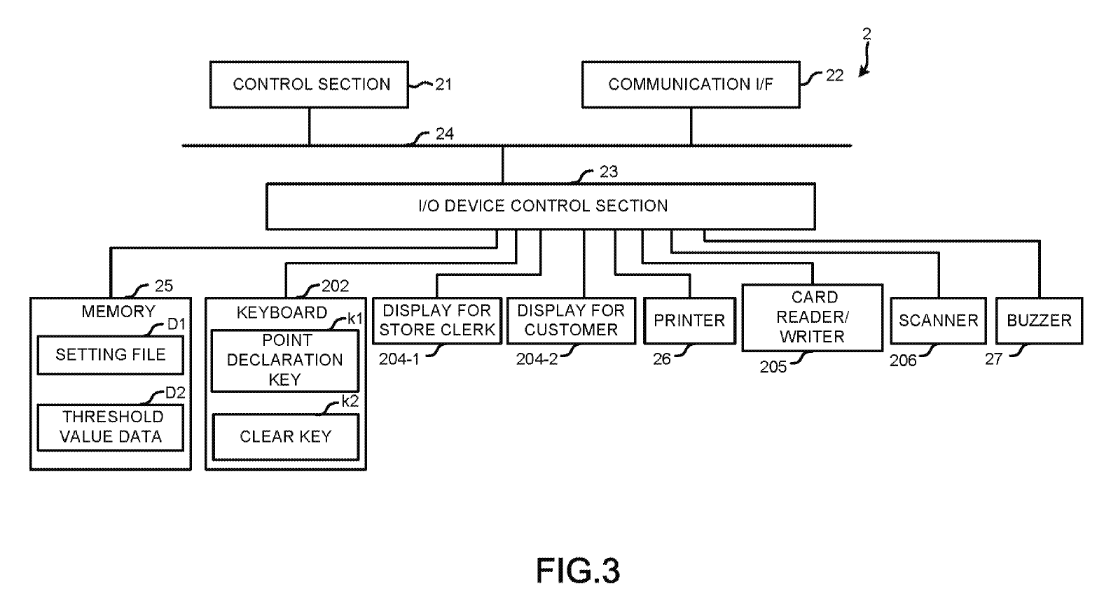

The main body 201 is provided with a keyboard 202 and mode keys for selecting various job modes such as a registration, a checking, a settlement and a setting at the front side thereof. The keyboard 202 is provided with operation keys, including numeric keys, a subtotal key, a cash total key, a closing key, a point declaration key k1 (refer to FIG. 3) and a clear key k2 (refer to FIG. 3), which are used to input various operations. The numeric keys are instruction keys for an operator to input deposited amount. The subtotal key is an instruction key for instructing output of total amount of commodities. The cash total key is pressed after the input of the deposited amount. The closing key is used to close the processing of one transaction. The point declaration key k1 is used to declare the start of the point processing. The clear key k2 is used to instruct the confirmation of display content such as a notification screen.

Furthermore, the main body 201 includes a display for store clerk 204-1 at the front side thereof and a display for customer 204-2 at the rear side thereof. The display for store clerk 204-1 and the display for customer 204-2 are, for example, liquid crystal displays. These displays indicate names and prices of the commodities in the sales registration processing and a total amount, a change amount and notification information of one transaction after the sales registration is completed.

A printer 26 (refer to FIG. 3) is arranged inside the main body 201 to print a receipt. The receipt printed by the printer 26 is issued from a receipt issuing port arranged at the front side of the main body 201.

The POS terminal 2 is provided with a card reader/writer 205 and a scanner 206 connected with the main body 201 through a signal cable. The card reader/writer 205 reads and writes information stored in a memory section (e.g., memory chip) of a point card C. The card reader/writer 205 conveys the point card C in the storage direction and carries out a reading processing to read point information of the point card C from the memory section. Further, the card reader/writer 205 carries out a writing processing to write the point information to the memory section after the point processing is performed. If the reading processing and writing processing are terminated, the point card is conveyed in the discharge direction and sent to a position where the point card can be taken out. The scanner 206 is, for example, a laser scanner that reads a barcode attached to a commodity.

The POS terminal 2 includes a service entrance of a communication line cable at the rear side of the main body 201.

FIG. 3 is a block diagram exemplifying the hardware of the POS terminal 2.

The POS terminal 2 is provided with a control section 21, a communication I/F 22 and an I/O device control section 23 that are connected with one another through a bus line 24.

The control section 21 is a control board equipped with a CPU, a ROM and a RAM. The ROM is a non-volatile memory that stores a control program and the like of the POS terminal 2. The control program contains a program relating to, for example, the determination of a dishonest accumulation of point values. The RAM is a volatile memory used by the CPU as a work area. The control section 21 controls the whole of the POS terminal 2 through the execution of various programs by the CPU.

The communication I/F 22 is used to connect the POS terminal 2 with the store computer 3 via the communication line 4 (refer to FIG. 1). Further, the communication I/F 22 operates as a communication interface that connects the POS terminal 2 with the point providing server. The communication I/F 22 is connected with the communication line cable drawn from the service entrance of the POS terminal 2. The communication I/F 22 sends the sales registration data to the store computer via the communication line cable under the control of the CPU. The communication I/F 22 further sends data relating to the point processing to the point providing server via the communication line cable.

The I/O device control section 23 is connected with I/O devices such as a memory 25, the keyboard 202, the display for store clerk 204-1, the display for customer 204-2, the printer 26, the card reader/writer 205, the scanner 206 and a buzzer 27. The I/O device control section 23 performs control of input/output between the control section 21 and the various I/O devices.

The memory 25 constituted with a hard disk and a flash ROM stores a setting file D1 and threshold value data D2. Moreover, the memory 25 also stores a commodity information file (not shown). The buzzer 27 issues a first buzzer sound (e.g., “pip”) to notify the completion of reading in response to the input of a commodity reading signal from the CPU when the scanner 206 reads a commodity.

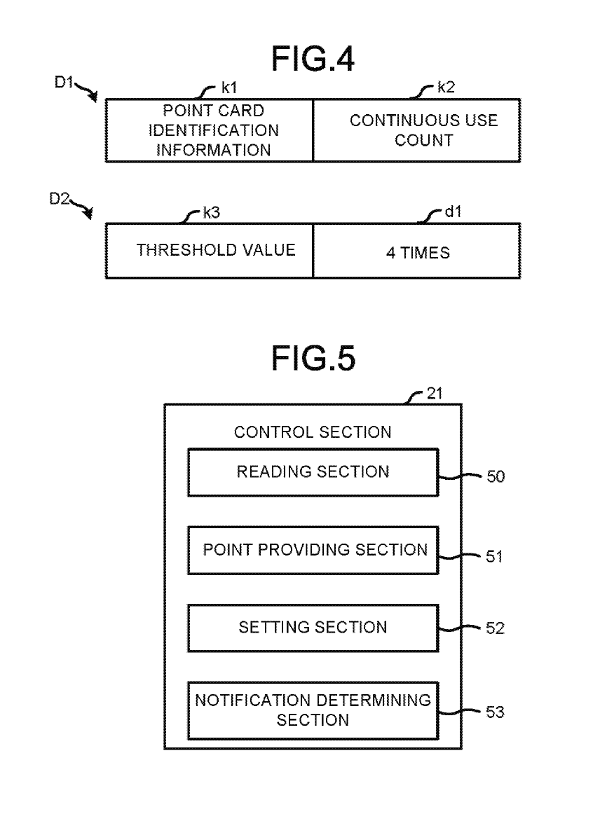

FIG. 4 is a diagram exemplifying data structures of the setting file D1 and the threshold value data D2. The setting file D1 shown in FIG. 4 has data items consisting of point card identification information K1 and continuous use count information (use count information) K2.

The point card identification information K1 stores owner identification information, for example, a code which is a combination of alphanumeric characters for identifying owner of a point card C (refer to FIG. 2). The owner identification information is a unique code associated with owner information registered by the owner when issuing the point card C. In the present embodiment, the unique code is formed with 5-digit numbers and stored in a storage section in a non-rewritable manner.

The continuous use count information K2 stores continuous use count if the identical or same point card C is used in the identical or same POS terminal 2 continuously.

Each data value of the setting file D1 is updated with new data value read by the CPU in each transaction.

The threshold value data D2 is not rewritable after the threshold value is initially set. Setting item “threshold value” K3 and its data value d1 (“4 counts”, as an example) are shown in FIG. 4. It is described hereinafter that the threshold value (upper limit value) of continuous use count of the same point card C is 4 counts shown in the data value d1.

The control section 21 realizes various functions through the execution of the control program by the CPU.

FIG. 5 is a functional block diagram illustrating the control section 21. Main functions relating to the determination of an unfair acquisition of points are exemplified. As shown in FIG. 5, the control section 21 functions as a reading section (reading module) 50, a point providing section (point module) 51, a setting section (storage module) 52 and a notification determining section (notification module) 53.

The reading section 50 controls the card reader/writer 205 (refer to FIG. 3) to read the owner identification information and the accumulated point value stored in the point card C (refer to FIG. 2). Specifically, the reading section 50 outputs an instruction signal of the start of reading to the card reader/writer 205 if the input signal from the point declaration key k1 is detected. If the owner identification information and the accumulated point value read by the card reader/writer 205 from the point card are output, the reading section 50 receives the owner identification information and the point value.

The point providing section 51 carries out an authentication processing for the owner identification information read from the point card C by the reading section 50. Then if the authentication processing is ended, a point value generated according to the total amount of commodities purchased by a customer is added to the point card C of the customer.

Specifically, the point providing section 51 sends the owner identification information received by the reading section 50 to the point providing server (not shown) to carry out the authentication processing. The point providing server inquires the owner identification information of a customer database upon receiving the owner identification information. Then, if the received owner identification information is matching with the registered owner identification information and is a point providing target, the point providing server replies notification data of providing points and data relating to a conversion formula of points to the POS terminal 2 serving as a requester. The point providing section 51 converts the total amount of the commodities purchased by the customer to a point value with the conversion formula upon receiving the notification data from the point grant server. Then, the point providing section 51 outputs the converted point value to the card reader/writer 205 and enables the card reader/writer 205 to update the accumulated point value of the point card C.

The setting section 52 reads the owner identification information of the point card identification information K1 in the setting file D1 stored in the memory 25 upon receiving the notification of providing points. Furthermore, the setting section 52 compares the owner identification information set in the point card identification information K1 and the owner identification information read by the reading section 50 to determine whether or not they are coincident with each other. If the both are not coincident with each other, the setting section 52 updates a setting value of the point card identification information K1 with the owner identification information read by the reading section 50. Further, the setting section 52 resets the value of the continuous use count information K2 to a default value “1”. On the other hand, if the both are coincident with each other according to the comparison result, the owner identification information set in the point card identification information K1 is unchanged, and the setting value of the continuous use count information K2 is reset to an increased value from a present value. For example, if the present value is “1”, the increased value to the present value is reset to “2”.

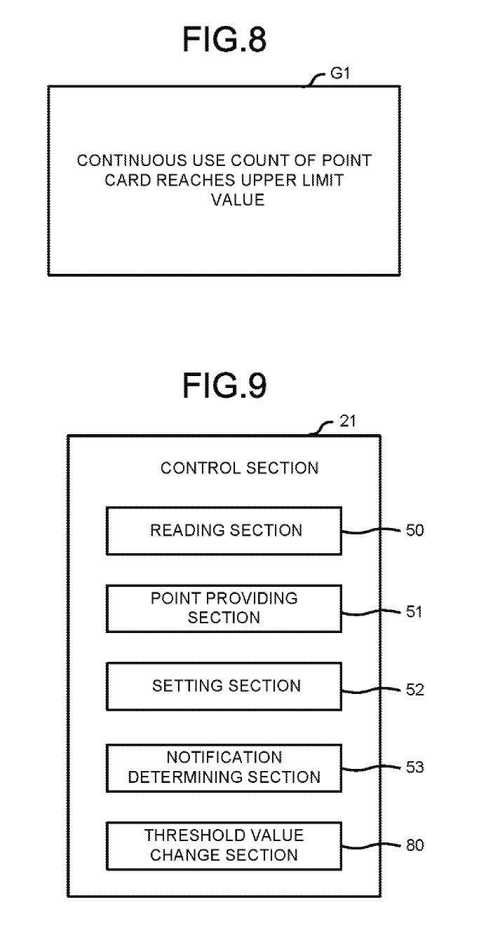

The notification determining section 53 reads the value of the continuous use count information K2 of which the setting is changed by the setting section 52 and the data value d1 (4 (times) in the present embodiment) of the threshold value data D2. Then, if the value of the continuous use count information K2 is greater than the threshold value (4 (times)) through the comparison of two values, the notification signal is output as occurrence of the unfair acquisition of the point value. In the present embodiment, a display control signal that enables the display for store clerk 204-1 (or display for customer 204-2) to display a notification screen G1 (refer to FIG. 8) is output as the notification signal.

Each function for detecting the above-mentioned unfair acquisition of the point value is mainly activated in one transaction in which a sales registration processing and a settlement processing are serially carried out. Though not shown in FIG. 5, various functions for realizing the sales registration processing and the settlement processing are also properly realized by the control section 21 at the time of the execution of these processing.

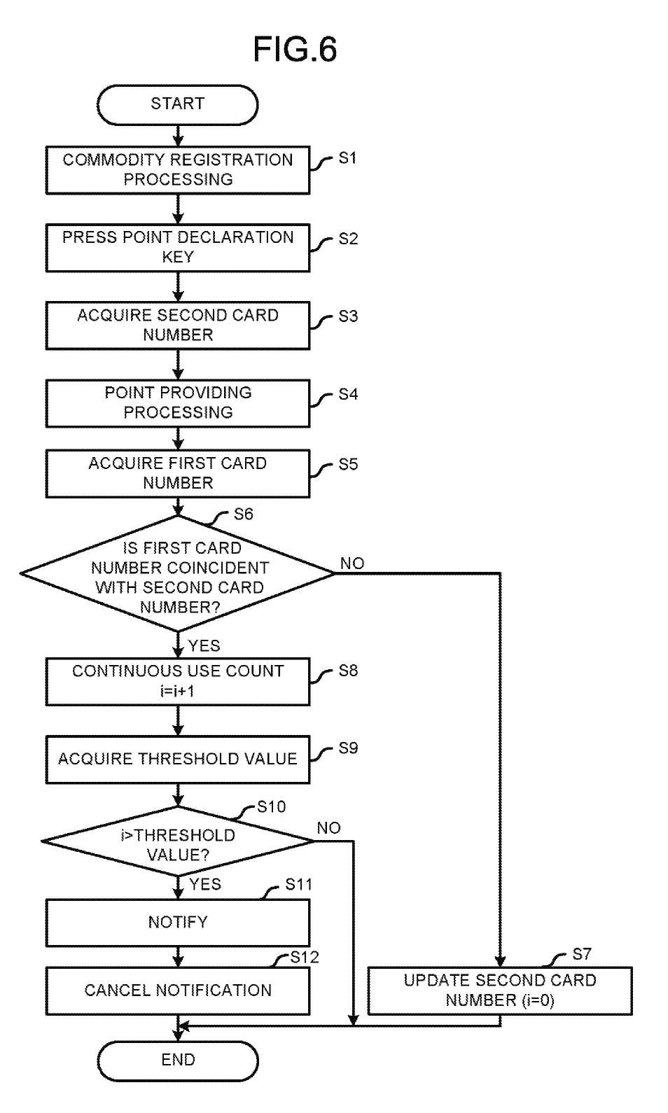

Next, the operations of the control section 21 are described. FIG. 6 is a flowchart illustrating the operations executed at the time of the point processing by the control section 21.

The control section 21 firstly carries out a sales registration processing of commodities purchased by a customer (ACT S1). The control section 21 reads commodity information of all the purchased commodities, generates a commodity list of one transaction and calculates a total amount of the purchased commodities in the sales registration processing. Specifically, an operator reads each barcode attached to each commodity with the scanner in order. The control section 21 acquires the commodity code of each commodity as decoded data of the barcode from the scanner. The control section 21 extracts commodity information such as names and prices of the commodities associated with these commodity codes from the commodity information file in the memory 25 to generate the commodity list of the purchased commodities. If the operator completes the input of the commodity codes of all the commodities and inputs the subtotal key, the control section 21 receives the input of the subtotal key to calculate the total amount. Afterwards, the operator carries out the input of deposited amount by the customer and presses the cash total key.

After the foregoing sales registration processing, the control section 21 receives the input of the point declaration key (ACT S2). After the total amount is calculated, the operator presses the point declaration key to add points corresponding to the total amount to a point card. The control section 21 executes a point processing described later upon receiving the input of the point declaration key. Further, if the operator inputs the closing key instead of the point declaration key, the control section 21 omits the point processing to execute a closing processing. For example, the control section 21 controls to open the drawer 203 to carry out the issue of a receipt.

In the point processing, firstly, the reading section 50 of the control section 21 acquires owner identification information (second card number) of the point card (ACT S3). Specifically, the reading section 50 receives an input signal (command) from the point declaration key k1. Then, the reading section 50 outputs an instruction signal (command) of the start of reading to the card reader/writer 205 according to the command of the input signal. The card reader/writer 205 starts a reading operation of the point card according to the command of the start of reading. The card reader/writer 205 conveys the point card to an internal reading position in the reading operation. Furthermore, the card reader/writer 205 reads a 5-digit unique code and an accumulated point value at the time of the sales registration processing from the memory of the point card as the owner identification information and outputs the read value. The reading section 50 acquires the read value output from the card reader/writer 205.

Next, the point providing section 51 of the control section 21 carries out the point providing processing (ACT S4). In the point providing processing, the point providing section 51 firstly inquires the authentication of the second card number of the point providing server. Then, if acquiring the authentication of the point providing server, the point providing section 51 calculates the point value corresponding to the total amount of the purchased commodities and outputs a new point value (updated point value) obtained by adding the calculated point value to the accumulated point value to the card reader/writer 205. The card reader/writer 205 overwrites the point value of the point card C with the new point value (updated point value) output by the point providing section 51 and discharges the point card C to a position at which the point card C can be taken out.

Subsequently, the control section 21 carries out a determination processing of unfair acquisition of a point value as part of the point processing as shown below.

Firstly, the setting section 52 of the control section 21 acquires a value (first card number) of the point card identification information K1 in the setting file D1 stored in the memory 25 (ACT S5). The first card number is a 5-digit unique code of the point card to which the points are added in a transaction just before this transaction is performed.

Next, the setting section 52 determines whether or not the first card number is coincident with the second card number acquired by the reading section 50 in the processing in ACT S3 (ACT S6).

If the result of the determination in ACT S6 is “not identical” (No in ACT S6), the setting section 52 updates the value in the setting file D1 stored in the memory 25 to the second card number (ACT S7). Specifically, the setting section 52 updates the setting value (first card number) of the point card identification information K1 in the setting file D1 to the second card number read by the reading section 50. Moreover, the setting section 52 resets a value (variable i) of the continuous use count information K2 to a default value “1”.

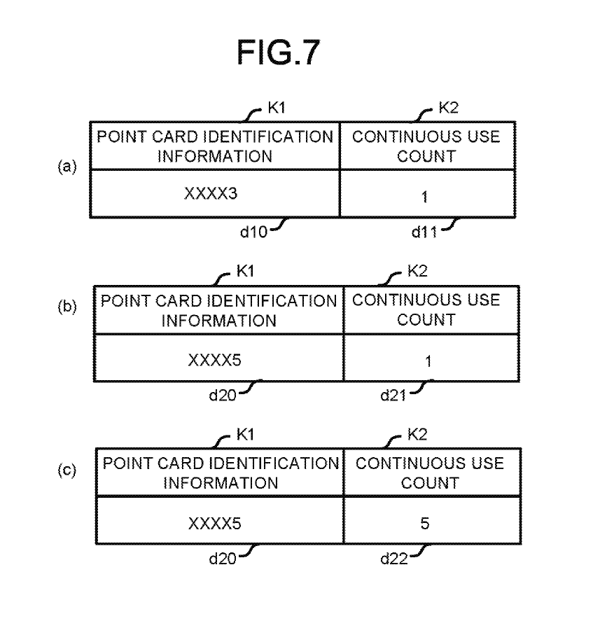

FIG. 7 (a) is a diagram illustrating an example of a setting state of the setting file D1 processed in ACT S7. In the example shown in FIG. 7 (a), it is shown that “XXXX3 (X represents an alphanumeric character)” is set as a data value d10 of the point card identification information K1. “1” is set as a data value d11 of the continuous use count information K2. It is assumed that the point card C assigned with the number “XXXX3” is not used in a transaction immediately before the present transaction. Thus, it is determined that the point card C with this number is used firstly at this time without being used continuously, and “1 (time)” is set as the continuous use count.

After the processing in ACT S7 shown in FIG. 6, the control section 21 ends the point processing and receives the closing key to enter a closing processing.

Even in a next transaction, the processing following ACT S1 is carried out similarly, and if the result of the determination in ACT S6 is “not identical”, points are added in the point card used in this transaction. Then, the setting value of the point card identification information K1 in the setting file D1 is updated to the number of the point card to which the points are added. Further, the value of the continuous use count information K2 is reset to the default value “1”.

FIG. 7 (b) is a diagram illustrating an example of a setting state of the setting file D1 at the time. In the example shown in FIG. 7(b), it is shown that a point card with number “XXXX5” is used in the transaction just after the transaction in which the point card with the number “XXXX3” is used. Thus, the “XXXX5” is set in the data value d20 of the point card identification information K1, a reset value “1” is set in the data value d21 of the continuous use count information K2.

Next, in the determination processing in ACT S6 of FIG. 6, a processing of a case in which the setting section 52 determines “identical” (Yes in ACT S6) is described.

Firstly, the setting section 52 resets the value of the continuous use count information K2 corresponding to the first card number in the setting file D1 to an increased value (ACT S8).

Then, the notification determining section 53 of the control section 21 reads the value i of the continuous use count information K2 in the setting file D1 and the data value d1 (4 (times)) in the threshold value data D2 (ACT S9). Then, through the comparison of the value i with the data value d1, it is determined whether or not the value i is greater than the threshold value (4 (times)) (ACT S10). In a case in which the identical or same point card is used continuously twice, i=2 (times) and i<threshold value (4 (times)) are satisfied. In this case, as it is determined that the value i is smaller than the threshold value (No in ACT S10), the control section 21 ends the point processing and receives the input signal of the closing key. If the operator operates the closing key, the control section 21 controls to open the drawer 203 and issue the receipt on which transaction content is printed as a closing processing.

Next, a processing of a case in which the identical point card is used continuously and the use count is greater than the threshold value is described. As an example, a case in which the point card with the identification information “XXXX5” shown in FIG. 7(b) is used 4 (four) times continuously and is used in the fifth time in a next transaction is described.

In the fifth transaction, the same processing from ACT S1 to ACT S6 (Yes in ACT S6) as described above are carried out. Then, in a processing in ACT S8 thereafter, the setting section 52 resets the value of the continuous use count information K2 corresponding to the first card number in the setting file D1 to an increased value “5 (times)”.

FIG. 7 (c) is a diagram illustrating an example of a setting state of the setting file D1 at the time. The value of the continuous use count information K2 is reset to “5” as shown in data value d22 of the continuous use count information K2 in FIG. 7(c).

Subsequently, after the reading operation in ACT S9, in ACT S10, the notification determining section 53 of the control section 21 determines whether or not the value i of the continuous use count information K2 in the setting file D1 is greater than the threshold value (4 (times)). As the identical or the same point card is used 5 times continuously, thus the value i is 5 (refer to FIG. 7(c)). Because of the value i (5)>the threshold value (4 (times)), the notification determining section 53 determines that the value i is greater than the threshold value (Yes in ACT S10).

If it is determined in ACT S10 that the value i is greater than the threshold value, the notification determining section 53 outputs a notification signal to notify occurrence of the unfair acquisition of a point value (ACT S11). In the present embodiment, the notification determining section 53 outputs a notification screen G1 (refer to FIG. 8) as the notification signal on the display for store clerk 204-1 (or the display for customer 204-2) in a pop-up manner.

Then, the control section 21 receives a signal (notification cancel signal) used for the cancel of the notification state (ACT S12). For example, a pressing signal of the clear key k2 arranged on the keyboard 202 is received as the notification cancel signal. If receiving the notification cancel signal, the control section 21 cancels the notification state, closes the notification screen G1 and receives the input signal of the closing key. After the closing key is operated, the control section 21 controls to open the drawer 203 and issue the receipt on which transaction content is printed as similar to the foregoing closing processing.

FIG. 8 is a diagram exemplifying the notification screen. The notification screen G1 shown in FIG. 8 is displayed on the display for store clerk 204-1. Notification information indicating “continuous use count of point card reaches upper limit value” is displayed to the cashier to prevent the unfair practice.

As stated above in the present embodiment, the threshold value of the continuous use count is set, and the continuous use count of the identical point card used in the same POS terminal is monitored. Then, if the continuous use count is greater than the threshold value, the notification is issued through the notification screen. If the cashier actually tries to perform the unfair practice in which his or her own point card is read, the unfair practice can be prevented through the notification. In a case in which a normal point providing processing on the point card of the customer is determined as an unfair practice through the notification, the notification is only needed to be canceled because points are already added to the point card of the customer.

In the present embodiment, as the notification module, an example is shown in which a notification screen is displayed on the display for store clerk to enable the cashier to refrain by himself or herself from the unfair practice. However, the present embodiment is not limited to this example, and may adopt another modification. For example, a special notification buzzer sound is issued to indicate a message that there is an unfair practice, or an LED or a revolving light is arranged to inform the inadequate activity. It may adopt a modification that the notification information is sent to a host device. According to the example of the notification module, it is possible to notify not only the cashier of the POS terminal, but also a customer (shopper), a cashier of another POS terminal and a manager of the store of the unfair practice.

The monitoring of the continuous use count of the identical point card in the same POS terminal is a determination reference for finding out an internal unfair practice in which the cashier acquires the points of the customer to add to his/her own point card. If the threshold value is too small, even a normal point providing processing in which, for example, the customer stands at the same checkout counter twice and uses the same point card is notified as an internal unfair practice in error. If the threshold value is too large, as a normal point providing processing in which another point card is used before the use count reaches the threshold value, the detection of the unfair practice is not carried out, and thus, the internal unfair practice cannot be detected even if it is performed. In the present embodiment, though the threshold value is set to 4 (times), the present embodiment is not limited to this, and a value that can increase the detection rate of the internal unfair practice may be set properly.

In the present embodiment, the continuous use count of the identical or the same point card used in the same POS terminal is monitored to find out the internal unfair practice in which the cashier intentionally acquires the points of the customer to add to his or her own point card. However, the monitoring of the use count of the identical point card is not limited to that of such continuous use count indicating the use from one transaction to a next transaction. For example, use count of the identical point card may be monitored at a prescribed transaction interval such as one transaction interval or two transaction intervals. In this case, a data set consisting of the point card identification information K1 and the continuous use count information K2 in the setting file D1 is held within the foregoing transaction interval until other point card is used. In this holding state of the data set, the value of the continuous use count information K2 is increased by 1 (one) each time a point card (identical point card) indicated with the point card identification information K1 is used. Then, it is determined that the point values are intentionally acquired with the unfair practice if the value of the continuous use count information K2 becomes greater than the threshold value.

Further, use count of the identical point card within a predetermined time may be monitored. In this case, the data set consisting of the point card identification information K1 and the continuous use count information K2 in the setting file D1 is held until the predetermined time elapses. In this state, the value of the continuous use count information K2 is increased by 1 (one) each time the point card indicated with the value of the point card identification information K1 is used. Then, it is determined that the point values are intentionally acquired with the unfair practice if the value of the continuous use count information K2 becomes greater than the threshold value.

In the present embodiment, the points are converted through the POS terminal, and the converted point value is added to the point card; however, it is not limited to this. These processing may partially or wholly carried out by the point providing server. For example, the conversion of the point value and the management of the point value may be carried out by the point providing server. In this case, the POS terminal reads the second card number from the point card and sends the read second card number to the point providing server. Furthermore, the POS terminal receives point providing information (e.g., added point value, total or accumulated point value, etc.) from the point providing server, and then carries out the determination processing in which acquisition of points with the unfair practice is detected.

Further, in the present embodiment, after the point providing is declared, the point value is added to the point card, and then the determination processing in which acquisition of points with the unfair practice is detected is carried out. However, it may be modified in such a manner that the determination processing in which acquisition of points with the unfair practice is detected is carried out before the point value is added. If the unfair practice is detected in this modification, the point providing processing is modified to a processing which does not add the point substantially, for example, 0 (zero) point is added to the point card. In this modification, if the normal point providing processing in which points are normally added to the point card of the customer is detected in error as the unfair practice, the point providing processing is carried out again for the point card of the customer.

(First Modification)

In the first modification, a POS terminal capable of changing a threshold value is described.

The POS terminal of the first modification further comprises a change module in addition to the structure of the POS terminal 2 of the embodiment. For example, a change procedure of the threshold value is depicted in the control program of the embodiment in advance as the change module. Then, the control section (CPU) of the POS terminal executes the control program to realize a function relating to the change module serving as a threshold value changing section in the control section.

FIG. 9 is a functional block diagram exemplifying the structure of the POS terminal of the first modification. As shown in FIG. 9, a threshold value changing section 80 is realized in the control section of the POS terminal of the first modification in addition to the functional block (refer to FIG. 5) shown in the embodiment. The functional block shown in FIG. 9 indicates main functions relating to the point processing of the POS terminal and, in the same way as the embodiment, other functions, for example, relating to the sales registration processing and the settlement processing are also realized properly.

The threshold value changing section 80 outputs, for example, a setting screen to the display for store clerk 204-1 if the POS terminal is in a setting mode with the operation of the mode key. The setting screen, which is pre-stored in the memory 25 (refer to FIG. 3), is a screen data for setting various parameter values of the POS terminal. The screen contains a setting item “threshold value change”. The setting item “threshold value change” is included in the setting screen. The setting item is arranged on the setting screen, for example, as an input area for inputting the threshold value with numerical value and a selection area for selecting one of a plurality of candidates with an up and down key.

Furthermore, the threshold value changing section 80 receives the input of a change value of the “threshold value” that is carried out in the input area and the selection area. Then, the change value is registered in the threshold value data D2 (refer to FIG. 3) of the memory 25 as a setting value. Specifically, the existing value indicated by the data value d1 of the threshold value data D2 is updated with the change value to register the change value as the setting value. For example, in a case of the existing value of the data value d1 “4 (times)” and the change value “3 (times)”, the data value d1 is updated from the existing value “4 (times)” to the change value “3 (times)”.

Through the update processing, “determination of the unfair acquisition of a point value” after the updating is carried out on the basis of a threshold value “3 (times)”. The operations of the point processing in a registration mode (refer to FIG. 6) are described similarly to the processing of the embodiment in FIG. 6 except that the threshold value serving as the determination reference in ACT S10 is decreased from “4” to “3”. Thus, the description of the operations more than the above is omitted, because it is repeated.

Probability of execution of a repeated settlement by one or the same customer who repeatedly comes to the same POS terminal depends on the number of the POS terminals arranged at the settlement register lane and the number of the customers who come to the store. Thus, an optimum setting value of the threshold value is also varied. Therefore, the POS terminal of the first modification is provided with the threshold value changing section to be able to change the setting value of the threshold value. Thus, even after the initial threshold value is set, the initial threshold value can be changed to a threshold value optimum to each store and each terminal according to the number of the POS terminals and the number of the customers and therefore the detection rate of the internal unfair practice can be increased.

(Second Modification)

In the second modification, the notification module of the embodiment is modified. Other than the notification screen display of the embodiment, for example, two kinds of buzzers which respectively issue buzzer sounds different from each other are used to notify an unfair practice.

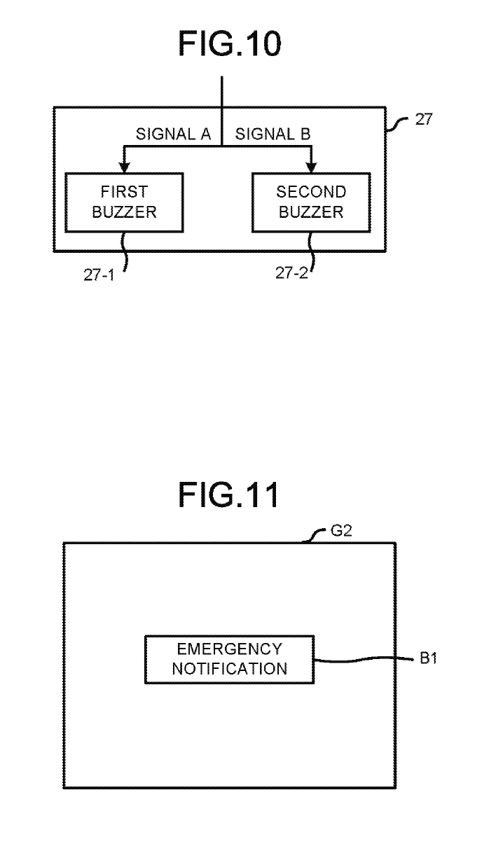

FIG. 10 is a diagram exemplifying the structure of a buzzer for notification.

As shown in FIG. 10, a buzzer for notification 27 includes two kinds of buzzers (a first buzzer 27-1 and a second buzzer 27-2). The first buzzer 27-1 issues a conventionally used sound (e.g., “pip”, etc.) which indicates that the barcode of a commodity is read. The second buzzer 27-2 continuously issues a special buzzer sound, for example, “beep” or specific melody until the cancel signal is input. The first buzzer 27-1 is driven by a signal A (e.g., 1 (one) pulse signal indicating a process from start to end) output when the control section reads the barcode of the commodity in the POS terminal of the second modification. The second buzzer 27-2 is driven by a signal B (1 (one) pulse signal indicating a start) output when the control section detects the unfair practice.

In the POS terminal of the second modification, as similar to the POS terminal of the embodiment, if the control section executes the point processing, the notification determining section 53 carries out the determination processing of the unfair practice in ACT S10 (refer to FIG. 6). Then, if the identical point card is used continuously plural times greater than the threshold value, the notification determining section 53 determines in ACT S10 that the use count is greater than the threshold value (Yes in ACT S10). In this case, the notification determining section 53 subsequently outputs the notification signal for notifying that the point value is inadequately acquired (ACT S11). In the POS terminal of the second modification, the foregoing display control signal and a buzzer sound control signal (signal B) are output as the notification signals at the time of detection of the inadequate acquisition.

Then, the control section receives, for example, the press signal of the clear key k2 on the keyboard 202 as the notification cancel signal for canceling the notification state (ACT S12). In the POS terminal of the second modification, if receiving the notification cancel signal, the control section clears the notification screen G1 and further outputs the signal B (1 (one) pulse signal indicating stop at this time) to the second buzzer 27-2 to stop the buzzer sound. Afterwards, the control section receives the input signal of the closing key as being similar to the embodiment.

As stated above, the POS terminal of the second modification, issues the special buzzer sound once the inadequate acquisition of the point value is detected, and thus the store clerks near the POS terminal can immediately find out the unfair practice. Further, even if the notified event is not an unfair practice, since the customer does not understand what the special buzzer sound notifies, the settlement is carried out as usual.

(Third Modification)

A POS terminal of the third modification outputs a signal that enables display of an icon for an emergency notification message to the host apparatus (store computer or headquarters server; a store computer in the present modification). The POS terminal of the third modification sends a command that enables the store computer to display the icon indicating the emergency notification message set therein to the store computer 3 at the time of the detection of the unfair acquisition of the point value.

The detection of the unfair acquisition of the point value in the POS terminal of the third modification is similar to the processing in the POS terminal 2 of the embodiment (refer to FIG. 6). The unfair acquisition of the point value is detected in such a manner that the notification determining section 53 determines in ACT S10 that the use count of the identical point card is greater than the threshold value (Yes in ACT S10). In this case, in ACT S11, the notification determining section 53 outputs the notification signal for notifying that the point value is inadequately added. The POS terminal of the third modification outputs, in addition to the display control signal shown in the embodiment, a communication instruction command to the communication I/F 22 (refer to FIG. 3) as the notification signal.

The communication instruction command is a sending command that enables the transmission of a command for displaying the icon indicating the emergency notification message to the host apparatus (store computer in the present modification). Specifically, the notification determining section 53 firstly outputs the display control signal to the display for store clerk 204-1 to display the notification screen G1 if the unfair acquisition of point value is detected. Then, the notification determining section 53 outputs the communication instruction command to the communication I/F 22. With the communication instruction command, the communication I/F 22 generates a transmission data containing the communication instruction command to send it to the store computer. Subsequently, as similar to the embodiment, the control section receives the notification cancel signal to clear the notification screen G1 (ACT S12) and then receives the input signal of the closing key.

On the other hand, if receiving the transmission data from the POS terminal, the store computer carries out a receiving processing and then extracts the communication instruction command from the transmission data. Then, the CPU of the store computer decodes the communication instruction command and outputs the icon for the emergency notification message stored in the store computer to the display of the store computer.

FIG. 11 is a diagram exemplifying a display screen on the display of the store computer. As shown in FIG. 11, the CPU of the store computer displays the emergency notification message icon B1 on a display screen G2. With this display, the manager of the store patrols the checkout counters or checkout lanes in the store or confirms images captured by a monitor camera arranged inside the store to confirm an operation manner with which the unfair practice is being performed.

The transmission data from the POS terminal may further contain information indicating the content of the emergency notification. For example, the information includes information indicating that the points are inadequately acquired and information indicating the terminal number of the POS terminal in which the unfair practice is being carried out. In this case, the store computer displays the emergency notification message icon B1 in the form of operable button as shown in FIG. 11 and receives input of the icon by pressing the button. If the manager of the store presses the icon (button), the input signal is received by the CPU and then the content of the emergency notification is displayed on the display of the store computer.

It may be modified in such a manner that only the signal that enables the display of the emergency notification message icon is output as the notification signal. In this case, in the POS terminal, the clear key k2 and the operation of canceling the notification in ACT S12 are unnecessary.

As stated above, in the third modification, if the POS terminal detects the unfair acquisition of the point value, the emergency notification message icon is displayed in the host device. In this way, the manager of the store can easily grasp the unfair acquisition of the point value performed in the store.

In a case in which only the signal that enables the display of the emergency notification message icon is output as the notification signal, the operation of canceling the notification by the operator of the POS terminal is unnecessary. Thus, the processing relating to the determination of the unfair practice is carried out at the background, and the operator executes the sales registration processing as similar to the conventional operation. Even if the unfair practice is detected, since the manager of the store grasps the unfair practice, it is unnecessary to interrupt the sales registration processing.

(Fourth Modification)

A POS terminal of the fourth modification outputs, as a transaction data, the identification number (responsible person number) of a person in charge of the POS terminal (cashier) and the card number of the point card to which the point value is added inadequately as transaction data to send it to the host apparatus.

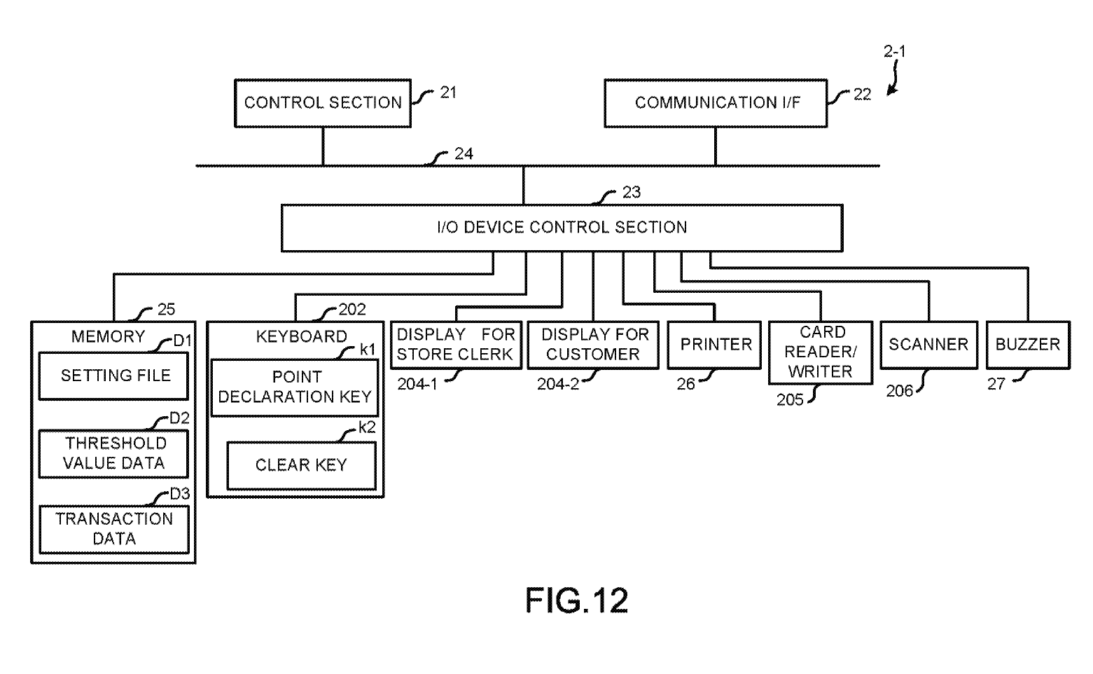

FIG. 12 is a diagram exemplifying the structure of the POS terminal of the fourth modification. A POS terminal 2-1 of the fourth modification shown in FIG. 12 further includes a memory 25 on which an area for storing transaction data D3 is arranged in the structure (refer to FIG. 3) of the POS terminal 2 of the embodiment.

In the POS terminal 2-1 of the fourth modification, the control section 21 stores data generated in a routine work such as the sales registration processing in the foregoing area as the transaction data D3. The data generated in the processing of the routine work includes the number of the point card read by the control section 21. The terminal number of the POS terminal 2-1 is also included in the transaction data D3, for example, as a file name.

The POS terminal 2-1 of the fourth modification sends the transaction data D3 stored in the foregoing area to the store computer when the unfair acquisition of the point value is detected.

The detection of the unfair acquisition of the point value in the POS terminal 2-1 of the fourth modification is similar to the processing of the POS terminal 2 of the embodiment (refer to FIG. 6). The unfair acquisition of the point value is detected in such a manner that the notification determining section 53 determines in ACT S10 that the use count of the identical point card is greater than the threshold value (Yes in ACT S10). Then, in ACT S11, the notification determining section 53 outputs a notification signal to notify that the point value is inadequately added. The POS terminal 2-1 of the fourth modification outputs, in addition to the display control signal shown in the embodiment, the transmission command of the transaction data D3 to the communication I/F 22 as the notification signal.

Specifically, if detecting the unfair acquisition of the point value, the notification determining section 53 firstly outputs the display control signal to the display for store clerk 204-1 to display the notification screen G1. Subsequently, the notification determining section 53 reads out the transaction data D3 from the foregoing area of the memory 25, and then outputs the transaction data D3 to the communication I/F 22 to command the transmission of the transaction data D3. The communication I/F 22 generates a transmission data including the transaction data D3 to send the transmission data to the store computer.

The POS terminal 2-1 of the fourth modification carries out the same processing as the POS terminal of the embodiment after the notification signal is output in ACT S11. The control section clears the notification screen G1 in ACT S12 and then receives the input signal of the closing key.

On the other hand, if receiving the transmission data from the POS terminal 2-1, the store computer carries out a receiving processing and then extracts the transaction data D3 from the transmission data. Then, the store computer stores the extracted transaction data D3 in a directory dedicated to the unfair acquisition.

From the above, the store manager can determine that the unfair acquisition of the point value is probably carried out at the checkout counter (POS terminal) referring to the transaction data D3 stored in the directory. Further, the manager can specify the POS terminal 2-1 in which the unfair acquisition is probably carried out according to the file name contained in the transaction data D3.

The transaction data D3 contains the history of the processing of the job at the POS terminal 2-1 at the time the unfair acquisition of the point value is carried out. Therefore, the store manager can specify a person in charge who probably performs the unfair acquisition of the point value with the transaction data D3. For example, the number of the used point card is read in a reverse order from the last part of the history contained in the transaction data D3, and thus it can be confirmed that the identical point card is continuously used over the threshold value. A person in charge of the POS terminal at the time the unfair practice is performed can be specified with the date and time of the use of the point card that is read from the transaction data D3.

Further, only information relating to the unfair acquisition is extracted from the transaction data D3, and it may be carried out that the extracted data is sent to the store computer instead of the transaction data D3. For example, a program for producing the above extracted data is stored in the ROM of the control section 21. The CPU of the control section 21 executes the producing program after the notification signal is output, and in this way, a function of a generation, section is realized in the control section 21.

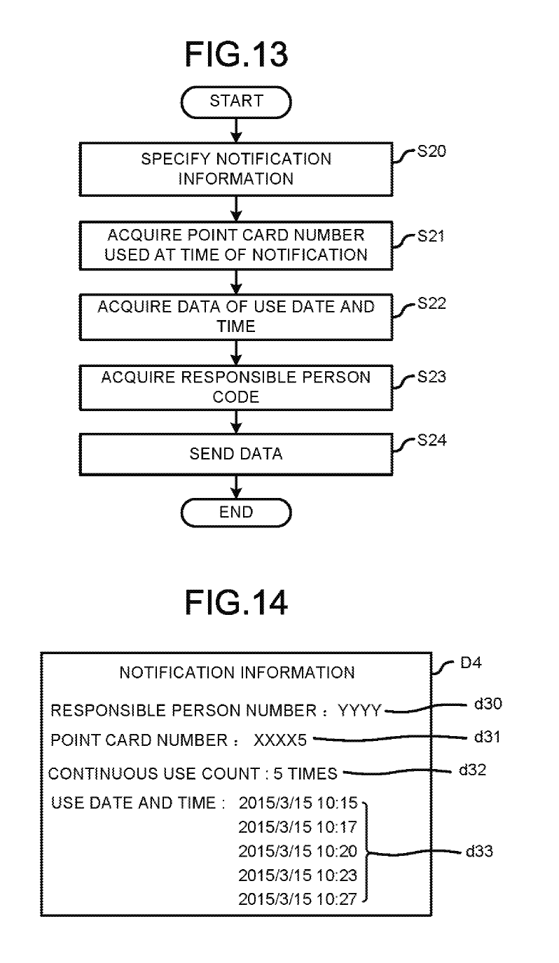

FIG. 13 is a flowchart exemplifying the processing of the generation section. The generation section firstly retrieves the transaction data D3 and specifies a position of the data (notification recording data) indicating that notification signal is output (ACT S20).

Next, the generation section acquires owner identification information (5-digit unique code in the present modification) in a position nearest to the specified position of the notification recording data, that is, the second card number used at the time of the notification from the transaction data D3 (ACT S21).

Furthermore, the transaction history is went back one by one from the specified position of the notification recording data to acquire data of the date and time on which the identical point card is used continuously from the transaction data D3 (ACT S22). At this time, the number of the acquired data described above is counted as a continuous use count.

Subsequently, the generation section acquires the identification number of the cashier (ACT S23). For example, the identification number (ID) of the cashier is input to the POS terminal 2-1 when the cashier firstly operates the POS terminal as a person in charge and thus is acquired.

Then, the generation section sends data (layout data) in which various data acquired from the transaction data D3 are arranged in a prescribed format to the store computer (ACT S24).

FIG. 14 is a diagram illustrating an example of the layout data sent to the store computer.

As shown in the layout data D4 in FIG. 14, an ID “YYYY (Y represents numeral)” indicating the identification number of the cashier in charge of the POS terminal 2-1 is arranged at the item d30. An ID “XXXX5” indicating the number of a point card to which the points are inadequately added is arranged at an item d31. Further, “5 times” indicating the continuous use count is arranged at an item d32 and all the use data and time respectively indicating each data and time of the continuous use are arranged at an item d33.

As stated above, only information relating to the unfair acquisition is extracted from the transaction data D3, and the extracted data is sent to the store computer instead of the transaction data D3. In this way, the store manager can receive only the information required to confirm at a glance the state of the terminal in which the unfair practice is performed.

In the present modification, the generation program is executed after the notification signal is output. The execution timing of the program may be a timing immediately after the notification signal is output or may be determined according to a predetermined transmission schedule. The timing determined according to the predetermined transmission schedule may be set at, for example, a timing at which the POS terminal 2-1 is shut down or timings at which a predetermined time elapses regularly.

In this way, since the layout data is sent to the host apparatus from the POS terminal 2-1 regularly, the store manager can also confirm the occurrence of the unfair acquisition of the point value later.

As stated above, each of the sales data processing apparatuses of the embodiment and each modification can detect the internal unfair practice in which the cashier adds the points of the customer generated at the time of the settlement of the commodities to his/her own point card.

Various programs used in the sales data processing apparatuses of the present embodiment and modifications may be recorded in a computer-readable recording medium such as a CD-ROM, an FD (Flexible disk), a CD-R and a DVD (Digital Versatile Disk) in the form of installable or executable file to be provided, or read by the memory of the sales data processing apparatus such as a flash ROM to be executed.

Further, the programs may be stored in a computer connected with a network such as an Internet or downloaded via the network to be provided.

While a sales data processing apparatus has been described in certain embodiments and modifications, these embodiments and modifications have been presented by way of example only, and are not intended to limit the scope of the invention. Indeed, the novel embodiments and modifications described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A sales data processing apparatus, comprising:
a reading module configured to read an owner identification information of a point card;
a point providing module configured to carry out a point providing processing in which a point value is added to the point card of which the owner identification information is read by the reading module;
a storage module configured to store the owner identification information of the point card to which the point providing processing is carried out and a use count information of the point card; and
a notification module configured to output a notification signal if the use count information of the point card, stored in the storage module, which is indicated by the owner identification information read by the reading module is greater than a threshold value.

2. The sales data processing apparatus according to claim 1, wherein
the use count information indicates one of a continuous use count of the point card in a series of transactions, a use count of the point card at a predetermined transaction interval, and a use count of the point card for a predetermined period.

3. The sales data processing apparatus according to claim 1, further comprising
a change module configured to change the threshold value.

4. The sales data processing apparatus according to claim 2, further comprising
a change module configured to change the threshold value.

5. The sales data processing apparatus according to claim 1, wherein
the notification module outputs the notification signal which enables a host apparatus to display an emergency notification message icon.

6. The sales data processing apparatus according to claim 1, wherein
the notification module sends both the owner identification information of the point card of which the use count information is greater than the threshold value and information of a number of a person in charge of the sales data processing apparatus to a host apparatus.

7. A method for detecting unfair acquisition of a point value by a sales data processing apparatus having a storage section, including:
reading an owner identification information of a point card;
carrying out a point providing processing in which a point value is added to the point card of which the owner identification information is read;
storing the owner identification information of the point card to which the point providing processing is carried out and a use count information of the point card in the storage section; and
outputting a notification signal if the use count information of the point card, stored in the storage section, which is indicated by the read owner identification information is greater than a threshold value.
